(19) United States
(12) Patent Application Publication
(10) Pub. No.: US 2014/0149218 A1
(43) Pub. Date: May 29, 2014

(54) PROMOTIONAL ITEM DELIVERIES BASED ON PLANNED/FUTURE TRAVELING

(71) Applicant: INTERNATIONAL BUSINESS MACHINES CORPORATION, Armonk, NY (US)

(72) Inventors: Kulvir S. Bhogal, Fort Worth, TX (US); Lisa Seacat DeLuca, San Francisco, CA (US); Lydia M. Do, Raleigh, NC (US)

(73) Assignee: International Business Machines Corporation, Armonk, NY (US)

(21) Appl. No.: 13/686,271

(22) Filed: Nov. 27, 2012

(51) Int. Cl. G06Q 30/02

(52) U.S. Cl. CPC G06Q 30/0261
USPC 705/14.58

(57) ABSTRACT

An approach for managing electronic promotional item(s) is presented. A plurality of subscriptions is submitted to at least one software service on behalf of a user. The submitted subscriptions are associated with respective geographical locations within a threshold distance from a travel route of a trip to a destination. The electronic promotional item(s) associated with respective geographical location(s) within the threshold distance are received from the at least one software service. The received electronic promotional item(s) are determined to be in effect between start and end dates of the trip. Based on the received electronic promotional item(s) being in effect between the start and end dates, at least a portion of the received electronic promotional item(s) is presented.

### TECHNICAL FIELD

The present invention relates to a data processing method and system for managing a promotional item, and more particularly to obtaining and displaying a promotional item based on a route of a planned trip.

### BACKGROUND

Social deal websites such as Groupon® and LivingSocial® allow users to view local deals in a variety of categories of products and services. The deals provided to a user by each of these websites, however, are initially limited to the single city in which the user lives or on which the user searches. If the user wants to obtain a deal for another city which is a destination in the user's upcoming vacation, then the user is required to subscribe to or search for the other city manually in each of the websites and then manually ensure that each deal provided by the websites is valid during the time the user is planning to visit the other city. If the user did subscribe to the other city, after the vacation is completed, the user is required to manually discontinue the deal delivery for the other city in each of the websites.

Groupon is a registered trademark of Groupon, Inc. located in Chicago, Ill. LivingSocial is a registered trademark of LivingSocial, Inc. located in Washington, D.C.

### BRIEF SUMMARY

In first embodiments, the present invention provides a method of managing electronic promotional item(s). The method includes a computer subscribing to at least one software service that delivers electronic promotional items to subscribers. Subscribing to the at least one software service includes submitting a plurality of subscriptions to the at least one software service on behalf of a user. The subscriptions in the plurality of subscriptions are associated with respective geographical locations within a threshold distance from a travel route of a trip to a destination. The method further includes, subsequent to the step of subscribing to the at least one software service, the computer receiving the electronic promotional item(s) from the at least one software service. The electronic promotional item(s) are associated with respective geographical location(s) included in the geographical locations within the threshold distance. The method further includes the computer determining the received electronic promotional item(s) will be in effect at respective point(s) in time between and inclusive of a start date of the trip and an end date of the trip. The method further includes, based on the received electronic promotional item(s) being in effect at the point(s) in time between and inclusive of the start and end dates, the computer generating a presentation of at least a portion of the received electronic promotional item(s).

In second embodiments, the present invention provides a computer program product, comprising a computer-readable, tangible storage device and a computer-readable program code stored in the computer-readable, tangible storage device. The computer-readable program code contains instructions that, when carried out by a central processing unit (CPU) of a computer system, implement a method of managing electronic promotional item(s). The method includes a computer system subscribing to at least one software service that delivers electronic promotional items to subscribers. Subscribing to the at least one software service includes the step of submitting a plurality of subscriptions to the at least one software service on behalf of a user. The subscriptions in the plurality of subscriptions are associated with respective geographical locations within a threshold distance from a travel route of a trip to a destination. The method further includes, subsequent to the step of subscribing to the at least one software service, the computer system receiving the electronic promotional item(s) from the at least one software service. The electronic promotional item(s) are associated with respective geographical location(s) included in the geographical locations within the threshold distance. The method further includes the computer system determining the received electronic promotional item(s) will be in effect at respective point(s) in time between and inclusive of a start date of the trip and an end date of the trip. The method further includes, based on the received electronic promotional item(s) being in effect at the point(s) in time between and inclusive of the start and end dates, the computer system generating a presentation of at least a portion of the received electronic promotional item(s).

In third embodiments, the present invention provides a process for supporting computing infrastructure. The process comprises a first computer system providing at least one support service for at least one of creating, integrating, hosting, maintaining, and deploying computer-readable code in a second computer system. The computer-readable code contains instructions that, when carried out by a processor of the second computer system, implement a method of managing an electronic promotional item. The method includes the second computer system subscribing to at least one software service that delivers electronic promotional items to subscribers. Subscribing to the at least one software service includes the step of submitting a plurality of subscriptions to the at least one software service on behalf of a user. The subscriptions in the plurality of subscriptions are associated with respective geographical locations within a threshold distance from a travel route of a trip to a destination. The method further includes, subsequent to the step of subscribing to the at least one software service, the computer system receiving the electronic promotional item(s) from the at least one software service. The electronic promotional item(s) are associated with respective geographical location(s) included in the geographical locations within the threshold distance. The method further includes the computer system determining the received electronic promotional item(s) will be in effect at respective point(s) in time between and inclusive of a start date of the trip and an end date of the trip. The method further includes, based on the received electronic promotional item(s) being in effect at the point(s) in time between and inclusive of the start and end dates, the computer system generating a presentation of at least a portion of the received electronic promotional item(s).

In fourth embodiments, the present invention provides a method of managing electronic promotional item(s). The method includes a computer receiving a plurality of electronic promotional items from software service(s) that deliver electronic promotional items to subscribers. The method further includes the computer identifying the electronic promotional item(s) within the plurality of electronic promotional items that satisfy a first condition that the identified electronic promotional item(s) are associated with respective geographical location(s) within a threshold distance from a travel route of a trip to a destination, and a second condition that the identified electronic promotional item(s) are in effect at respective point(s) in time between and inclusive of a start date of the trip and an end date of the trip. The method further includes based on the identified electronic promotional item(s) satisfying the first and second conditions, the computer generating a presentation of at least respective portions of the identified electronic promotional item(s).

Embodiments of the present invention automatically obtain promotional items from a plurality of social deal websites based on the location and timing of a future or planned trip.

### BRIEF DESCRIPTION OF THE DRAWINGS

FIG. 1 depicts a block diagram of a system for managing an electronic promotional item, in accordance with embodiments of the present invention.

FIGS. 2A-2B depicts a flowchart of a process of managing electronic promotional item(s) received via a submission of subscriptions to at least one service that delivers promotional items, where the process is implemented in the system of FIG. 1, in accordance with embodiments of the present invention.

FIG. 3 is a flowchart of a process of managing electronic promotional item(s) without requiring a submission of subscriptions, where the process is implemented in the system of FIG. 1, in accordance with embodiments of the present invention.

FIG. 4 is an example of a display provided in the process of FIGS. 2A-2B, in accordance with embodiments of the present invention.

FIG. 5 is a block diagram of a computer system that is included in the system of FIG. 1 and that implements the process of FIGS. 2A-2B or the process of FIG. 3, in accordance with embodiments of the present invention.

### DETAILED DESCRIPTION

### Overview

Embodiments of the present invention manage electronic promotional items for a user based on the user's future or planned trip. An embodiment of the present invention identifies the future or planned trip, and subsequently determines the travel route of the trip and geographical locations (e.g., cities) along the travel route (i.e., geographical locations different from where the user resides). An embodiment of the present invention attempts to match geographical locations along the travel route to locations for which electronic promotional items are provided by one or more software services (e.g., social deal websites such as the Groupon® website). In an embodiment of the present invention, electronic promotional items provided by the software services are received and those electronic promotional items that are associated with the matched geographical locations are automatically checked to ensure they are redeemable in a time period during which the trip is scheduled to occur. The electronic promotional items that are associated with the matched geographical locations and are redeemable in the aforementioned time period may be delivered to the user for viewing. The electronic promotional items may be received and delivered to the user without requiring the user to manually subscribe to the different geographical locations. In an embodiment of the invention, after the trip is completed, the delivery of electronic promotional items to the user is discontinued automatically.

As used herein, an electronic promotional item is defined as a document, certificate, ticket or code that can be redeemed or otherwise used to obtain a financial reward, discount or rebate for the purchase of a product or service from a seller, and that is included in, attached to, linked to, or otherwise accessible from a website or from an email, text message or other digital message sent via a computer network to a user's computer, mobile device, or other computing device. Electronic promotional items include, for example, internet coupons and discounted gift certificates provided by social deal websites such as the Groupon® website.

Hereinafter, an electronic promotional item is also referred to simply as a “promotional item.”

### System for Managing a Promotional Item

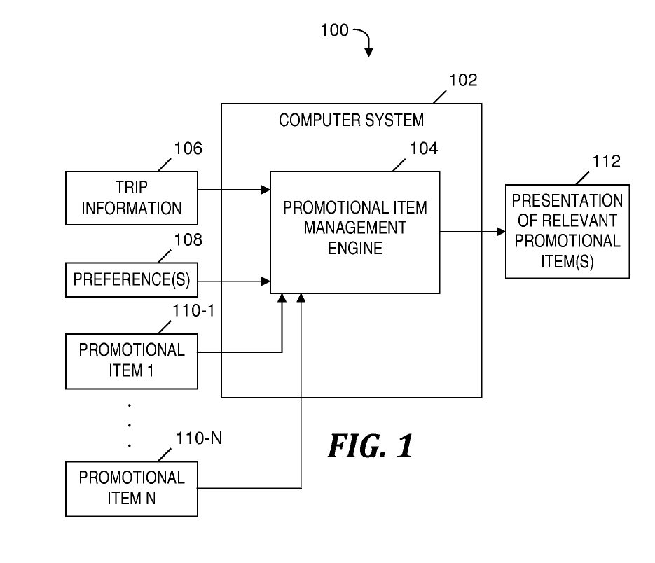

FIG. 1 depicts a block diagram of a system for managing an electronic promotional item, in accordance with embodiments of the present invention. System 100 includes a computer system 102, which runs a software-based promotional item management engine 104. Promotional item management engine 104 receives or determines trip information 106 (i.e., information about an upcoming trip that is being planned or arranged). Trip information 106 may include the destination of the trip, the travel route planned or likely to be taken to the destination, the start date of the trip and the end date of the trip.

Promotional item management engine 104 also receives preference(s) 108 of a user. Preference(s) 108 include a threshold distance the user is willing to deviate from the travel route to obtain a deal associated with a promotional item.

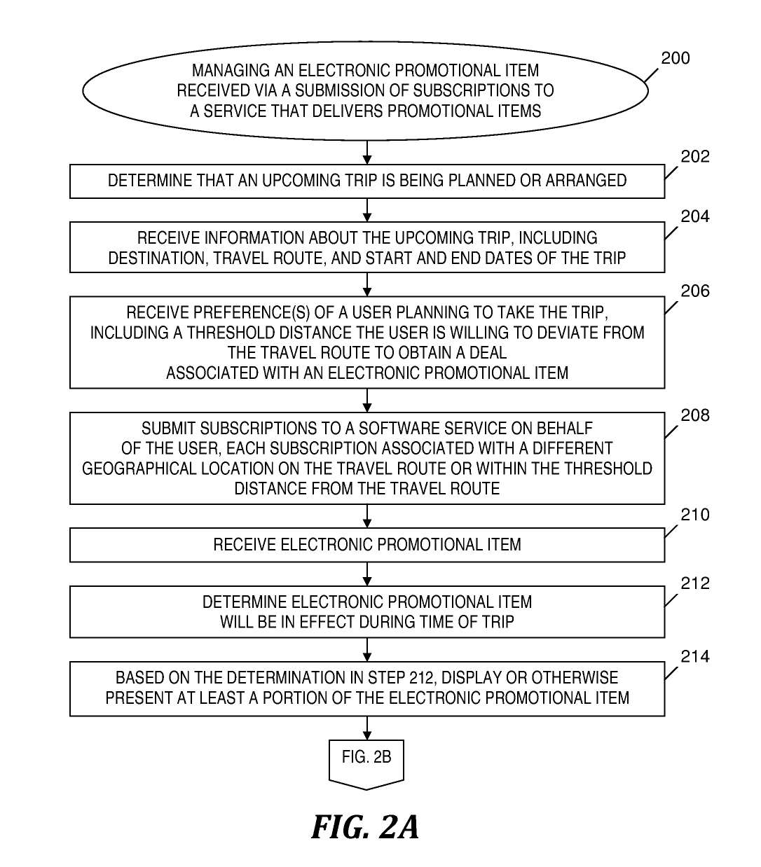

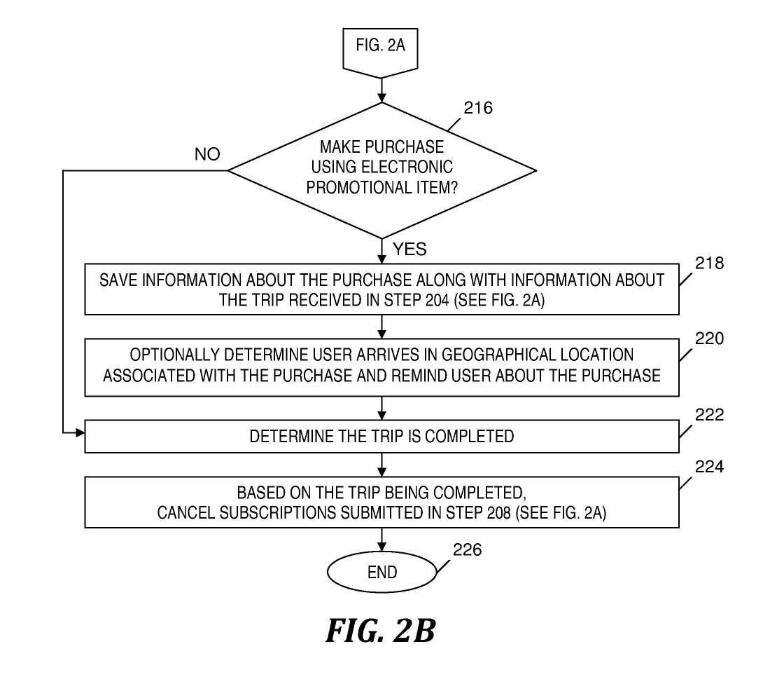

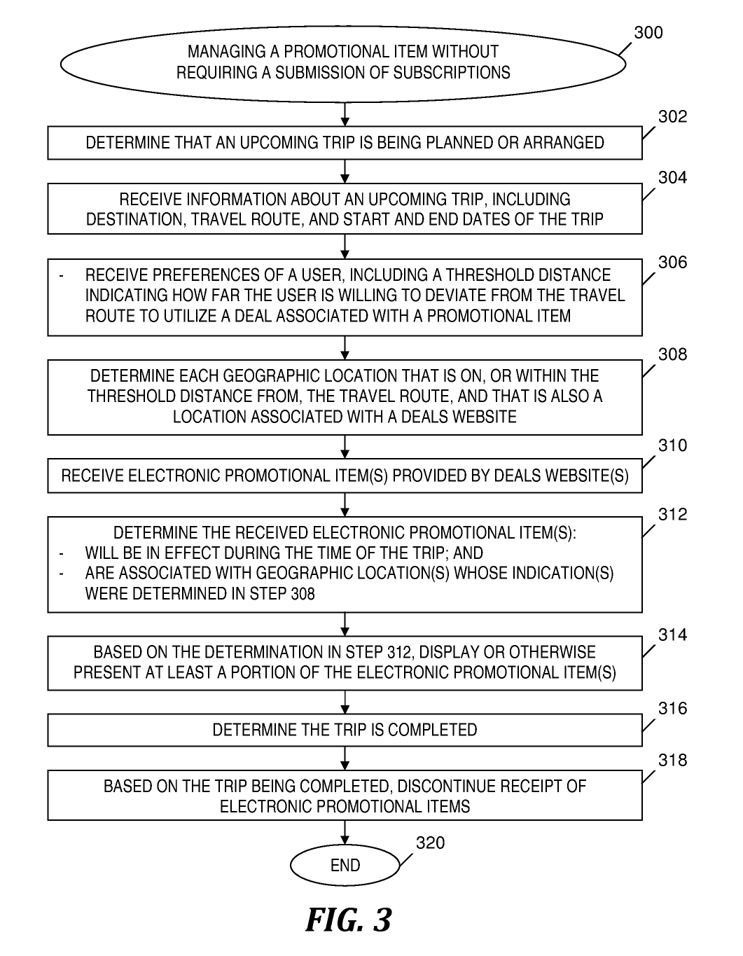

Promotional item management engine 104 receives promotional item 1 . . . promotional item N (i.e., promotional item 110-1 . . . promotional item 110-N), where N is an integer greater than 1. After determining whether each of the received promotional items satisfies one or more conditions described below relative to FIGS. 2A-2B and FIG. 3, promotional item management engine 104 generates or directs a display device to generate a presentation 112 that includes at least portions of relevant promotional item(s) (i.e., one or more of the received promotional items that satisfy the aforementioned one or more conditions).

The functionality of the components shown in FIG. 1 is described in more detail in the discussions of FIGS. 2A-2B and FIG. 3 presented below.

### Process for Managing a Promotional Item

FIGS. 2A-2B depicts a flowchart of a process of managing promotional item(s) received via a submission of subscriptions to at least one service that delivers promotional items, where the process is implemented in the system of FIG. 1, in accordance with embodiments of the present invention. The process of FIGS. 2A-2B starts at step 200. In step 202, promotional item management engine 104 (see FIG. 1) determines that an upcoming trip by a user is being planned or arranged. The determination of an upcoming trip may be based on determining that a route has been entered in a Global Positioning System (GPS), a trip has been entered into a software-based calendar system, a flight or train ticket has been purchased, a hotel room has been purchased, a rental car has been purchased, or an indication of the trip has been manually entered by the user into computer system 102 (see FIG. 1).

In step 204, promotional item management engine 104 (see FIG. 1) receives and/or determines trip information 106 (see FIG. 1) (i.e. information about the upcoming trip). The trip information received or determined in step 204 may include the destination of the trip, a travel route that is planned or is likely to be taken to the destination, and start and end dates of the trip. Promotional item management engine 104 (see FIG. 1) may receive all or some of the trip information received in step 204 from a GPS system, a calendar system, information received about purchases (e.g., hotel room, flight tickets, or rental car) made by or on behalf of the user, or manual data entries received by computer system 102 (see FIG. 1). If the upcoming trip is being taken by a group of people, then the promotional item management engine 104 (see FIG. 1) may receive trip information 106 (see FIG. 1) from group trip planning software.

In one embodiment, after step 204 and prior to step 206, promotional item management engine 104 (see FIG. 1) determines the destination city (i.e., the city of the destination of the trip) and any cities (i.e., travel route cities) or other locations that are on the travel route received in step 204. A city or other location is on the travel route if the user passes through the city while traveling on the travel route. Promotional item management engine 104 (see FIG. 1) checks the destination city and the travel route cities or other locations against a list of geographic locations (e.g., cities) associated with software service(s) that deliver promotional items. In one embodiment, the software service(s) include social deal website(s). If the destination city, travel route city, or other location is on the list of geographic locations associated with social deal websites, then promotional item management engine 104 (see FIG. 1) may mark the city or other location and save an indication thereof in a data repository. As used herein, a geographic location is associated with a software service if the software service provides at least one electronic promotional item that promotes or offers a product and/or service that can be obtained or purchased from a business or other organization located in the geographic location.

In step 206, promotional item management engine 104 (see FIG. 1) receives preference(s) 108 (see FIG. 1) of the user who is planning to take the upcoming trip. The preference(s) 108 (see FIG. 1) received in step 206 includes a threshold distance, which indicates a maximum distance the user is willing to deviate from the travel route to obtain a deal associated with a promotional item (e.g., promotional item 110-1 in FIG. 1). For example, the user may set a preference that indicates she is willing to drive up to 5 miles away from a planned travel route to redeem an electronic coupon received and delivered to the user by promotional item management engine 104 (see FIG. 1).

The preference(s) 108 (see FIG. 1) received in step 206 may include a category of product or category of service in which the user is interested. For example, a user sets a preference to indicate that only promotional items related to food items are to be delivered to the user.

The preference(s) 108 (see FIG. 1) received in step 206 may include an amount of time in advance of the start of the trip for starting delivery of promotional items 110-1 . . . 110-N (see FIG. 1) to the user. For example, the user sets a preference of two weeks to indicate that delivery of relevant promotional items to the user is to be started two weeks before the start date of the trip.

In one embodiment, the trip is being taken by a group of people and step 206 includes receiving respective preferences of the people in the group.

In step 208, promotional item management engine 104 (see FIG. 1) submits, on behalf of the user, subscriptions to a software service that delivers promotional items to users. Each subscription is associated with a different geographical location on the travel route or within the threshold distance from the travel route. In one embodiment, the different geographical locations are different cities.

In step 210, promotional item management engine 104 (see FIG. 1) receives a promotional item (e.g., promotional item 110-1 in FIG. 1) offered by the software service to which the subscriptions were submitted in step 208. Hereinafter, in the discussion of FIGS. 2A-2B, the promotional item received in step 210 is referred to as “the received promotional item.” The promotional item management engine 104 (see FIG. 1) determines in step 210 that the received promotional item is associated with a geographical location that is on the travel route or is within the threshold distance from the travel route. A promotional item is associated with a geographical location if the user can obtain or purchase the product or service associated with the promotional item when the user is in the geographical location.

In step 212, promotional item management engine 104 (see FIG. 1) determines the received promotional item will be in effect at a point in time between and inclusive of the start and end dates of the trip (i.e., in effect during the time of the trip). A promotional item being in effect at a point in time means the promotional item is redeemable at the point in time or the product or service associated with the promotional item may be used or received at the point in time.

In step 214, based on the determination in step 212 that the received promotional item will be in effect at the aforementioned point in time, promotional item management engine 104 (see FIG. 1) generates or directs a device to generate the presentation 112 (see FIG. 1) of at least a portion of the received promotional item.

In one embodiment, step 214 includes the promotional item management engine 104 (see FIG. 1) directing a display device to generate a display of at least a portion of the received promotional item for viewing by the user. In another embodiment, step 214 includes the promotional item management engine 104 (see FIG. 1) directing a printing device to print the received promotional item. In yet another embodiment, step 214 includes the promotional item management engine 104 (see FIG. 1) delivering the received promotional item via an e-mail sent to the user.

Following step 214, the process of FIGS. 2A-2B continues with step 216 in FIG. 2B. In step 216, promotional item management engine 104 (see FIG. 1) determines whether or not the user makes a purchase by redeeming or otherwise using the received promotional item. If promotional item management engine 104 (see FIG. 1) determines in step 216 that the user makes the aforementioned purchase, then the Yes branch of step 216 is taken and step 218 is performed.

In step 218, promotional item management engine 104 (see FIG. 1) saves in a data repository information about the aforementioned purchase along with information about the trip received in step 204 (see FIG. 2A). In step 220, promotional item management engine 104 (see FIG. 1) optionally determines that the user arrives in the geographical location associated with the product or service that was purchased by using the received promotional item, and in response thereto, sends a notification to the user to remind the user about the purchase.

Step 222 follows step 220 and also follows the No branch of step 216, which is taken if promotional item management engine 104 (see FIG. 1) determines in step 216 that the user does not make a purchase using the received promotional item. In step 222, promotional item management engine 104 (see FIG. 1) determines that the trip is completed.

In step 224, based on the determination in step 222 that the trip is completed, promotional item management engine 104 (see FIG. 1) cancels the subscriptions submitted in step 208 (see FIG. 2A). The process of FIGS. 2A-2B ends at step 226.

In one embodiment, steps 210 and 212 (see FIG. 2A) may be repeated one or more times to receive one or more other promotional items provided by the software service and/or provided by other software service(s), and to determine that the received one or more other promotional items are in effect at respective point(s) in time during the trip. The received one or more other promotional items are associated with respective one or more geographical locations, which are included in the geographical locations associated with the subscriptions submitted in step 208 (see FIG. 2A). Subsequently, in step 214 (see FIG. 2A), the promotional item management engine 104 (see FIG. 1) generates presentation 112 (see FIG. 1), which includes multiple promotional items from the software service (i.e., the received promotional item and the received one or more other promotional items).

In an alternate embodiment, a variation of step 208 (see FIG. 2A) submits subscriptions to multiple software services (e.g., multiple social deal websites) on behalf of the user, where each software service delivers promotional items to users. Variations of steps 210 and 212 (see FIG. 2A) are repeated to receive respective sets of promotional items that are provided by the multiple software services, and to determine the promotional items in the respective sets are in effect during the time of the trip. Subsequently, in step 214 (see FIG. 2A), the promotional item management engine 104 (see FIG. 1) generates the presentation 112 (see FIG. 1), which includes the sets of promotional items provided by the multiple software services.

In an alternate embodiment, a tolerance level (e.g., a distance beyond the threshold distance or a percentage of the threshold distance) is included in the preference(s) received in step 206 (see FIG. 2A), and the subscriptions submitted in step 208 (see FIG. 2A) includes a subscription associated with an additional geographical location that is within the tolerance level relative to the threshold distance from the travel route. A promotional item associated with the additional geographical location may be received in step 210 (see FIG. 2A) and displayed in step 214 (see FIG. 2A). In step 214 (see FIG. 2A), promotional item management engine 104 (see FIG. 1) includes a warning in presentation 112 (see FIG. 1) to indicate that the promotional item is associated with a location that is at a distance that is close to, but beyond the threshold distance from the travel route.

In one embodiment, during the trip being taken by the user, promotional item management engine 104 (see FIG. 1) determines that the user is deviating from the travel route received in step 204. Based on the deviation from the travel route, the promotional item management engine 104 (see FIG. 1) determines an updated travel route that is at least in part different from the travel route received in step 204. In response to determining the updated travel route, the promotional item management engine 104 (see FIG. 1) receives other electronic promotional item(s) associated with other geographic location(s) within the threshold distance received in step 206. The other geographic location(s) may include at least one geographic location that was not within the threshold distance from the initial travel route, but is within the threshold distance from the updated travel route.

FIG. 3 is a flowchart of a process of managing an electronic promotional item without requiring a submission of subscriptions, where the process is implemented in the system of FIG. 1, in accordance with embodiments of the present invention. The process of FIG. 3 starts at step 300. In step 302, promotional item management engine 104 (see FIG. 1) determines that an upcoming trip is being planned or arranged. The determination made in step 302 may be performed as described above relative to step 202 (see FIG. 2A).

In step 304, promotional item management engine 104 (see FIG. 1) receives or determines trip information 106 (see FIG. 1). The trip information received or determined in step 304 may include the destination of the trip, a travel route that is planned or is likely to be taken to the destination, and start and end dates of the trip. Promotional item management engine 104 (see FIG. 1) may receive all or some of the trip information from a GPS system, a calendar system, information received about purchases (e.g., hotel room, flight tickets, or rental car) made by or on behalf of the user, or manual data entries received by computer system 102 (see FIG. 1). If the upcoming trip is being taken by a group of people, then the promotional item management engine 104 (see FIG. 1) may receive trip information 106 (see FIG. 1) from group trip planning software.

In one embodiment, after step 304 and prior to step 306, promotional item management engine 104 (see FIG. 1) determines the destination city (i.e., the city of the destination of the trip) and any cities (i.e., travel route cities) or other locations that are on the travel route received or determined in step 304. A city or other location is on the travel route if the user passes through the city while traveling on the travel route. Promotional item management engine 104 (see FIG. 1) checks the destination city, the travel route cities and the aforementioned other locations against a list of geographic locations (e.g., cities) associated with software service(s) that deliver promotional items. In one embodiment, the software service(s) include social deal websites. If the destination city, travel route city, or other location is on the list of geographic locations associated with social deal websites, then promotional item management engine 104 (see FIG. 1) may mark the city or other location and save an indication thereof in a data repository. As used herein, a geographic location is associated with a software service if the software service provides at least one electronic promotional item that promotes or offers a product and/or service that can be obtained or purchased from a business or other organization located in the geographic location.

In step 306, promotional item management engine 104 (see FIG. 1) receives preference(s) 108 (see FIG. 1) of the user who is planning to take the upcoming trip. The preference(s) 108 (see FIG. 1) received in step 306 includes a threshold distance, which indicates a maximum distance (e.g., 5 miles) the user is willing to deviate from the travel route to obtain a deal associated with a promotional item (e.g., promotional item 110-1 in FIG. 1).

In one embodiment, the preference(s) 108 (see FIG. 1) received in step 306 include a category (e.g., food) of a product or a category of a service in which the user is interested. In one embodiment, the preference(s) 108 (see FIG. 1) received in step 306 includes an amount of time (e.g., two weeks) in advance of the start of the trip for starting delivery of promotional items 110-1 . . . 110-N (see FIG. 1) to the user.

In one embodiment, the trip is being taken by a group of people and step 306 includes receiving preferences of the people in the group.

In step 308, promotional item management engine 104 (see FIG. 1) determines and may store an indication of each geographic location that is on, or within the threshold distance from, the travel route, and that is also a location associated with a corresponding software service (e.g., social deals website) that delivers promotional items to users.

In step 310, promotional item management engine 104 (see FIG. 1) receives a promotional item (e.g., promotional item 110-1 in FIG. 1) provided by a software service that delivers promotional items. Hereinafter, in the discussion of FIG. 3, the promotional item received in step 310 is referred to as “the received promotional item.”

In one embodiment, promotional item management engine 104 (see FIG. 1) receives the promotional item in step 310 via an Application Programming Interface (API) that the software service has set up to deliver promotional items.

In step 312, the promotional item management engine 104 (see FIG. 1) determines that the received promotional item (1) will be in effect at a point in time between and inclusive of the start and end dates of the trip; and (2) is associated with a geographic location determined in step 308. In one embodiment, step 312 also includes the promotional item management engine 104 (see FIG. 1) determining that the received promotional item is associated with a product or service that is in the category received in step 306.

In step 314, based on the determinations made in step 312, including the determinations that the received promotional item will be in effect at the aforementioned point in time, and is associated with a geographic location determined in step 308, promotional item management engine 104 (see FIG. 1) generates or directs a device to generate the presentation 112 (see FIG. 1) of at least a portion of the received promotional item. In one embodiment, step 314 includes the promotional item management engine 104 (see FIG. 1) directing a display device to generate a display of at least a portion of the received promotional item for viewing by the user. In another embodiment, step 314 includes the promotional item management engine 104 (see FIG. 1) directing a printing device to print the received promotional item. In yet another embodiment, step 314 includes the promotional item management engine 104 (see FIG. 1) delivering the received promotional item via an e-mail sent to the user.

In alternate embodiment, the promotional item management engine 104 (see FIG. 1) delivers the received promotional item to the user by including the received promotional item in an email sent to the user.

In step 316, promotional item management engine 104 (see FIG. 1) determines that the trip is completed.

In step 318, based on the determination in step 316 that the trip is completed, promotional item management engine 104 (see FIG. 1) discontinues receipt of promotional items. The process of FIG. 3 ends at step 320.

In one embodiment, steps 310 and 312 may be repeated one or more times to receive one or more other promotional items provided by the aforementioned software service and/or provided by other software service(s), and to determine that the received one or more other promotional items satisfy the conditions in step 312. The received one or more other promotional items are associated with respective one or more geographical locations determined in step 308. Subsequently, in step 314, the promotional item management engine 104 (see FIG. 1) generates presentation 112 (see FIG. 1), which includes the multiple promotional items provided by the software service(s) (i.e., the received promotional item and the received one or more other promotional items).

In an alternate embodiment, step 306 includes receiving a preference of a tolerance level (e.g., a distance beyond the threshold distance or a percentage of the threshold distance) and step 308 includes determining and optionally storing an indication of an additional geographical location that is within the tolerance level relative to the threshold distance from the travel route. A promotional item associated with the additional geographical location may be received in step 310 and displayed in step 314. In step 314, the promotional item management engine 104 (see FIG. 1) presents a warning to the user that the promotional item is associated with a location that is at a distance that is close to, but beyond the threshold distance from the travel route.

In one embodiment, during the trip being taken by the user, promotional item management engine 104 (see FIG. 1) determines that the user is deviating from the travel route received or determined in step 304. Based on the deviation from the travel route, the promotional item management engine 104 (see FIG. 1) determines an updated travel route that is at least in part different from the travel route received or determined in step 304. In response to determining the updated travel route, the promotional item management engine 104 (see FIG. 1) receives other electronic promotional item(s) associated with other geographic location(s) within the threshold distance received in step 306. The other geographic location(s) may include at least one geographic location that was not within the threshold distance from the initial travel route, but is within the threshold distance from the updated travel route.

### EXAMPLE

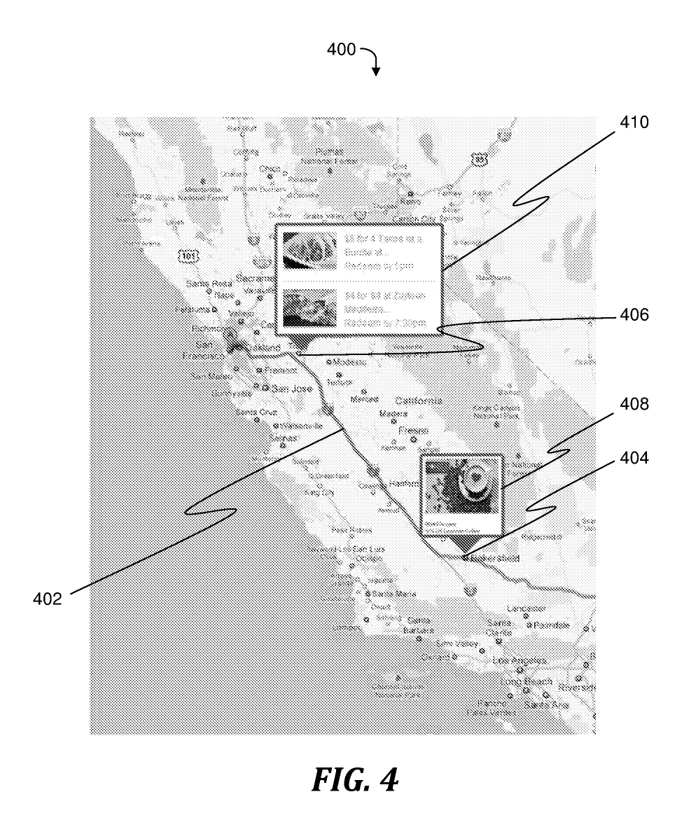

FIG. 4 is an example of a display 400 provided in the process of FIGS. 2A-2B, in accordance with embodiments of the present invention. In this example, promotional item management engine 104 (see FIG. 1) receives information that Bob rented a car for the upcoming week of Thanksgiving and has booked a hotel room in Las Vegas for dates during the upcoming week of Thanksgiving. The promotional item management engine 104 (see FIG. 1) determines in step 202 (see FIG. 2A) that Bob is planning to take a trip from his local city, San Francisco, to Las Vegas for the week of Thanksgiving. Because Bob rented a car, promotional item management engine 104 (see FIG. 1) assumes that Bob will be driving from San Francisco to Las Vegas for the trip. The promotional item management engine 104 (see FIG. 1) receives travel route 402 in step 204 (see FIG. 2A).

The promotional item management engine 104 (see FIG. 1) determines a list of cities, including cities 404 and 406, which are either on the travel route 402 or within a threshold distance from the travel route 402. The promotional item management engine 104 (see FIG. 1) determines that city 404 is included on travel route 402. The promotional item management engine 104 (see FIG. 1) determines that city 406 is not on travel route 402, but is within a threshold distance of the travel route, where the threshold distance is received in step 206 (see FIG. 2A).

The promotional item management engine 104 (see FIG. 1) generates display 400 for viewing by Bob, where display 400 includes an excerpt of a travel route 402 of the trip from San Francisco to Las Vegas (not shown). Display 400 is an example of presentation 112 (see FIG. 1), which is generated in step 214 (see FIG. 2A). Display 400 includes a portion of a first promotional item 408, which is associated with city 404. Display 400 also includes a portion of a second promotional item 410, which is associated with city 406. Promotional items 408 and 410 are included in display 400 as a result of repeated performances of step 214 (see FIG. 2A).

### Computer System

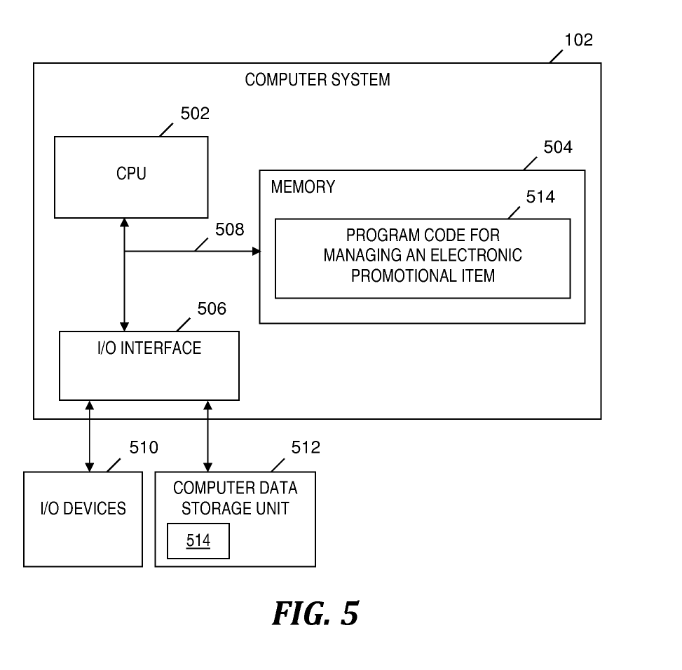

FIG. 5 is a block diagram of a computer system that is included in the system of FIG. 1 and that implements the process of FIGS. 2A-2B or the process of FIG. 3, in accordance with embodiments of the present invention. Computer system 102 generally comprises a central processing unit (CPU) 502, a memory 504, an input/output (I/O) interface 506, and a bus 508. Further, computer system 102 is coupled to I/O devices 510 and a computer data storage unit 512. CPU 502 performs computation and control functions of computer system 102, including carrying out instructions included in program code 514 to perform a method of managing a promotional item described in FIGS. 2A-2B or FIG. 3, where the instructions are carried out by CPU 502 via memory 504. CPU 502 may comprise a single processing unit, or be distributed across one or more processing units in one or more locations (e.g., on a client and server). In one embodiment, program code 514 includes code for the promotional item management engine 104 (see FIG. 1).

Memory 504 may comprise any known computer-readable storage medium, which is described below. In one embodiment, cache memory elements of memory 504 provide temporary storage of at least some program code (e.g., program code 514) in order to reduce the number of times code must be retrieved from bulk storage while instructions of the program code are carried out. Moreover, similar to CPU 502, memory 504 may reside at a single physical location, comprising one or more types of data storage, or be distributed across a plurality of physical systems in various forms. Further, memory 504 can include data distributed across, for example, a local area network (LAN) or a wide area network (WAN).

I/O interface 506 comprises any system for exchanging information to or from an external source. I/O devices 510 comprise any known type of external device, including a display device (e.g., monitor), keyboard, mouse, printer, speakers, handheld device, facsimile, etc. Bus 508 provides a communication link between each of the components in computer system 102, and may comprise any type of transmission link, including electrical, optical, wireless, etc.

I/O interface 506 also allows computer system 102 to store information (e.g., data or program instructions such as program code 514) on and retrieve the information from computer data storage unit 512 or another computer data storage unit (not shown). Computer data storage unit 512 may comprise any known computer-readable storage medium, which is described below. For example, computer data storage unit 512 may be a non-volatile data storage device, such as a magnetic disk drive (i.e., hard disk drive) or an optical disc drive (e.g., a CD-ROM drive which receives a CD-ROM disk).

Memory 504 and/or storage unit 512 may store computer program code 514 that includes instructions that are carried out by CPU 502 via memory 504 to manage a promotional item. Although FIG. 5 depicts memory 504 as including program code 514, the present invention contemplates embodiments in which memory 504 does not include all of code 514 simultaneously, but instead at one time includes only a portion of code 514.

Further, memory 504 may include other systems not shown in FIG. 5, such as an operating system (e.g., Linux®) that runs on CPU 502 and provides control of various components within and/or connected to computer system 102. Linux is a registered trademark of Linus Torvalds in the United States, other countries, or both.

Storage unit 512 and/or one or more other computer data storage units (not shown) that are coupled to computer system 102 may store trip information 106 (see FIG. 1), preference(s) 108 (see FIG. 1), and promotional item 110-1 (see FIG. 1) . . . promotional item 110-N (see FIG. 1).

As will be appreciated by one skilled in the art, in a first embodiment, the present invention may be a system; in a second embodiment, the present invention may be a method; and in a third embodiment, the present invention may be a computer program product. A component in an embodiment of the present invention may take the form of an entirely hardware-based component, an entirely software component (including firmware, resident software, micro-code, etc.) or a component combining software and hardware sub-components that may all generally be referred to herein as a “module”.

An embodiment of the present invention may take the form of a computer program product embodied in one or more computer-readable medium(s) (e.g., memory 504 and/or computer data storage unit 512) having computer-readable program code (e.g., program code 514) embodied or stored thereon.

Any combination of one or more computer-readable mediums (e.g., memory 504 and computer data storage unit 512) may be utilized. The computer readable medium may be:

(1) a computer-readable storage medium, as described below, or

(2) a computer-readable signal medium, as described below.

Computer-Readable Storage Medium:

As used herein, a computer-readable storage medium is not a computer-readable signal medium. In one embodiment, the computer-readable storage medium is a physical, tangible computer-readable storage device or physical, tangible computer-readable storage apparatus that is not a propagating signal. A computer-readable storage medium may be, for example, an electronic, magnetic, optical, electromagnetic, or semiconductor system, apparatus, device or any suitable combination of the foregoing that is not a propagating signal. A non-exhaustive list of more specific examples of the computer-readable storage medium includes: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium is a physical, tangible storage medium that can contain or store a program (e.g., program 514) for use by or in connection with a system, apparatus, or device for carrying out instructions in the program, and which is not a propagating signal.

Computer-Readable Signal Medium:

A computer-readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with a system, apparatus, or device for carrying out instructions.

Program code (e.g., program code 514) embodied on a computer-readable medium may be transmitted using any appropriate medium, including but not limited to wireless, wireline, optical fiber cable, radio frequency (RF), etc., or any suitable combination of the foregoing.

Computer program code (e.g., program code 514) for carrying out operations for aspects of the present invention may be written in any combination of one or more programming languages, including an object oriented programming language such as Java®, Smalltalk, C++ or the like and conventional procedural programming languages, such as the “C” programming language or similar programming languages. Java and all Java-based trademarks are trademarks or registered trademarks of Oracle and/or its affiliates. Instructions of the program code may be carried out entirely on a user's computer, partly on the user's computer, as a stand-alone software package, partly on the user's computer and partly on a remote computer or entirely on the remote computer or server, where the aforementioned user's computer, remote computer and server may be, for example, computer system 102 or another computer system (not shown) having components analogous to the components of computer system 102 included in FIG. 5. In the latter scenario, the remote computer may be connected to the user's computer through any type of network (not shown), including a LAN or a WAN, or the connection may be made to an external computer (e.g., through the Internet using an Internet Service Provider).

Aspects of the present invention are described herein with reference to flowchart illustrations (e.g., FIGS. 2A-2B and FIG. 3) and/or block diagrams of methods, apparatus (systems) (e.g., FIG. 1 and FIG. 5), and computer program products according to embodiments of the invention. It will be understood that each block of the flowchart illustrations and/or block diagrams, and combinations of blocks in the flowchart illustrations and/or block diagrams, can be implemented by computer program instructions (e.g., program code 514). These computer program instructions may be provided to one or more hardware processors (e.g., CPU 502) of a general purpose computer, special purpose computer, or other programmable data processing apparatus to produce a machine, such that the instructions, which are carried out via the processor(s) of the computer or other programmable data processing apparatus, create means for implementing the functions/acts specified in the flowcharts and/or block diagram block or blocks.

These computer program instructions may also be stored in a computer-readable medium (e.g., memory 504 or computer data storage unit 512) that can direct a computer (e.g., computer system 102), other programmable data processing apparatus, or other devices to function in a particular manner, such that the instructions (e.g., program 514) stored in the computer-readable medium produce an article of manufacture including instructions which implement the function/act specified in the flowcharts and/or block diagram block or blocks.

The computer program instructions may also be loaded onto a computer (e.g., computer system 102), other programmable data processing apparatus, or other devices to cause a series of operational steps to be performed on the computer, other programmable apparatus, or other devices to produce a computer implemented process such that the instructions (e.g., program 514) which are carried out on the computer, other programmable apparatus, or other devices provide processes for implementing the functions/acts specified in the flowcharts and/or block diagram block or blocks.

Any of the components of an embodiment of the present invention can be deployed, managed, serviced, etc. by a service provider that offers to deploy or integrate computing infrastructure with respect to managing a promotional item. Thus, an embodiment of the present invention discloses a process for supporting computer infrastructure, wherein the process comprises a first computer system providing at least one support service for at least one of integrating, hosting, maintaining and deploying computer-readable code (e.g., program code 514) in a second computer system (e.g., computer system 102) comprising one or more processors (e.g., CPU 502), wherein the processor(s) carry out instructions contained in the code causing the second computer system to manage a promotional item.

In another embodiment, the invention provides a method that performs the process steps of the invention on a subscription, advertising and/or fee basis. That is, a service provider, such as a Solution Integrator, can offer to create, maintain, support, etc. a process of managing a promotional item. In this case, the service provider can create, maintain, support, etc. a computer infrastructure that performs the process steps of the invention for one or more customers. In return, the service provider can receive payment from the customer(s) under a subscription and/or fee agreement, and/or the service provider can receive payment from the sale of advertising content to one or more third parties.

The flowcharts in FIGS. 2A-2B and FIG. 3 and the block diagrams in FIG. 1 and FIG. 5 illustrate the architecture, functionality, and operation of possible implementations of systems, methods, and computer program products according to various embodiments of the present invention. In this regard, each block in the flowcharts or block diagrams may represent a module, segment, or portion of code (e.g., program code 514), which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of managing electronic promotional item(s), the method comprising the steps of:
a computer subscribing to at least one software service that delivers electronic promotional items to subscribers by submitting a plurality of subscriptions to the at least one software service on behalf of a user, the subscriptions in the plurality of subscriptions being associated with respective geographical locations within a threshold distance from a travel route of a trip to a destination;
subsequent to the step of subscribing to the at least one software service, the computer receiving the electronic promotional items(s) from the at least one software service, the electronic promotional item(s) associated with respective geographical location(s) included in the geographical locations within the threshold distance;
the computer determining the received electronic promotional item(s) will be in effect at respective point(s) in time between and inclusive of a start date of the trip and an end date of the trip; and
based on the received electronic promotional item(s) being in effect at the point(s) in time between and inclusive of the start and end dates, the computer generating a presentation including at least a portion of the received electronic promotional item(s).

2. The method of claim 1, further comprising the step of:
prior to the step of subscribing to the at least one software service, the computer receiving a value for the threshold distance, the value representing a maximum distance the user is willing to deviate from the travel route to act upon each of the electronic promotional item(s).

3. The method of claim 1, further comprising the steps of:
during the trip, the computer determining the user is deviating from the travel route;
based on the user deviating from the travel route, the computer determining an updated travel route; and
in response to the step of determining the updated travel route, the computer receiving other electronic promotional item(s) associated with other geographical location(s) within the threshold distance from the updated travel route.

4. The method of claim 1, further comprising the steps of:
the computer determining a conclusion of the end date of the trip; and
based on the conclusion of the end date of the trip, the computer automatically directing the software service to cancel the plurality of subscriptions.

5. The method of claim 1, wherein the step of receiving the electronic promotional item(s) is performed at one or more first points in time between and inclusive of the start date and the end date, or at one or more second points in time prior to the start date.

6. A computer program product, comprising:
a computer-readable, tangible storage device; and
a computer-readable program code stored in the computer-readable, tangible storage device, the computer-readable program code containing instructions that are carried out by a central processing unit (CPU) of a computer system to implement a method of managing an electronic promotional item, the method comprising the steps of:
a computer system subscribing to at least one software service that delivers electronic promotional items to respective subscribers by submitting a plurality of subscriptions to the at least one software service on behalf of a user, the subscriptions in the plurality of subscriptions being associated with respective geographical locations within a threshold distance from a travel route of a trip to a destination;
subsequent to the step of subscribing to the at least one software service, the computer system receiving the electronic promotional item(s) from the software service, the electronic promotional item(s) associated with respective geographical location(s) included in the geographical locations within the threshold distance;
the computer system determining the received electronic promotional item(s) will be in effect at respective point(s) in time between and inclusive of a start date of the trip and an end date of the trip; and
based on the received electronic promotional item(s) being in effect at the point(s) in time between and inclusive of the start and end dates, the computer system generating a presentation including at least a portion of the received electronic promotional item(s).

7. The program product of claim 6, wherein the method further comprises the step of:
prior to the step of subscribing to the at least one software service, the computer system receiving a value for the threshold distance, the value representing a maximum distance the user is willing to deviate from the travel route to act upon each of the electronic promotional item(s).

8. The program product of claim 6, further comprising the steps of:
during the trip, the computer determining the user is deviating from the travel route;
based on the user deviating from the travel route, the computer determining an updated travel route; and
in response to the step of determining the updated travel route, the computer receiving other electronic promotional item(s) associated with other geographical location(s) within the threshold distance from the updated travel route.

9. The program product of claim 6, wherein the method further comprises the steps of:
the computer system determining a conclusion of the end date of the trip; and
based on the conclusion of the end date of the trip, the computer system automatically directing the software service to cancel the plurality of subscriptions.

10. The program product of claim 6, wherein the step of receiving the electronic promotional item(s) is performed at one or more first points in time between and inclusive of the start date and the end date, or at one or more second points in time prior to the start date.

11. A process for supporting computing infrastructure, the process comprising:
a first computer system providing at least one support service for at least one of creating, integrating, hosting, maintaining, and deploying computer-readable code in a second computer system, the computer-readable code containing instructions, wherein the instructions, when carried out by a processor of the second computer system, implement a method of managing an electronic promotional item, the method comprising the steps of:
the second computer system subscribing to at least one software service that delivers electronic promotional items to subscribers by submitting a plurality of subscriptions to the at least one software service on behalf of a user, the subscriptions in the plurality of subscriptions being associated with respective geographical locations within a threshold distance from a travel route of a trip to a destination;
subsequent to the step of subscribing to the at least one software service, the second computer system receiving the electronic promotional item(s) from the at least one software service, the electronic promotional item(s) associated with respective geographical location(s) included in the geographical locations within the threshold distance;
the second computer system determining the received electronic promotional item(s) will be in effect at respective point(s) in time between and inclusive of a start date of the trip and an end date of the trip; and
based on the received electronic promotional item(s) being in effect at the point(s) in time between and inclusive of the start and end dates, the second computer system generating a presentation including at least a portion of the received electronic promotional item(s).

12. The process of claim 11, wherein the method further comprises the step of:
prior to the step of subscribing to the at least one software service, the second computer system receiving a value for the threshold distance, the value representing a maximum distance the user is willing to deviate from the travel route to act upon each of the electronic promotional item(s).

13. The process of claim 11, wherein the method further comprises the steps of:
during the trip, the second computer system determining the user is deviating from the travel route;
based on the user deviating from the travel route, the second computer system determining an updated travel route; and
in response to the step of determining the updated travel route, the second computer system receiving other electronic promotional item(s) associated with other geographical location(s) within the threshold distance from the updated travel route.

14. The process of claim 11, wherein the method further comprises the steps of:
the second computer system determining a conclusion of the end date of the trip; and
based on the conclusion of the end date of the trip, the second computer system automatically directing the software service to cancel the plurality of subscriptions.

15. The process of claim 11, wherein the step of receiving the electronic promotional item(s) is performed at one or more first points in time between and inclusive of the start date and the end date, or at one or more second points in time prior to the start date.

16. A method of managing electronic promotional item(s), the method comprising the steps of:
a computer receiving a plurality of electronic promotional items from software service(s) that deliver electronic promotional items to subscribers;
the computer identifying the electronic promotional item(s) within the plurality of electronic promotional items that satisfy a first condition that the identified electronic promotional item(s) are associated with respective geographical location(s) within a threshold distance from a travel route of a trip to a destination, and a second condition that the identified electronic promotional item(s) are in effect at respective point(s) in time between and inclusive of a start date of the trip and an end date of the trip; and
based on the identified electronic promotional item(s) satisfying the first and second conditions, the computer directing a display device to display at least respective portions of the identified electronic promotional item(s).

17. The method of claim 16, further comprising the steps of:
the computer receiving one or more preferences of a user who is planning to take the trip, the one or more preferences including a specification of a category of goods or services in which the user has an interest; and
the computer determining the identified electronic promotional item(s) are included in the category,
wherein the step of directing the display device to display at least the respective portions of the identified electronic promotional item(s) is further based on the identified electronic promotional item(s) being included in the category.

18. The method of claim 16, further comprising the steps of:
the computer determining a first user and a second user are planning to take the trip together;
the computer receiving one or more preferences of the first user and one or more preferences of the second user, the one or more preferences of the first user being different from the one or more preferences of the second user; and
the computer determining the identified electronic promotional item(s) satisfy the one or more preferences of the first user and the one or more preferences of the second user,
wherein the step of directing the display device to display at least the respective portions of the identified electronic promotional items is further based on the identified electronic promotional item(s) satisfying the one or more preferences of the first user and the one or more preferences of the second user.

19. The method of claim 16, further comprising the step of:
prior to the step of identifying electronic promotional item(s) that satisfy the first and second conditions, the computer receiving a value for the threshold distance, the value representing a maximum distance the user is willing to deviate from the travel route to act upon each of the electronic promotional item(s).

20. The method of claim 16, further comprising the steps of:
during the trip, the computer determining the user is deviating from the travel route;
based on the user deviating from the travel route, the computer determining an updated travel route; and
in response to the step of determining the updated travel route, the computer receiving other electronic promotional item(s) associated with other geographical location(s) within the threshold distance from the updated travel route.
